(19) United States
(12) Patent Application Publication
(10) Pub. No.: US 2008/0065795 A1
(43) Pub. Date: Mar. 13, 2008

(54) Method for enabling two sets of I/O peripherals to operate the same host in centralized computer system

(75) Inventors: Te-Hsien Lai, Taipei Shien (TW); Chin-Tsai Yen, Taipei (TW); Chih-Feng Mai, Taipei Shien (TW); Ming-Chien Yang, Taipei Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/878,393

(22) Filed: Jul. 24, 2007

(30) Foreign Application Priority Data
Sep. 8, 2006 (TW) 095133373

(51) Int. Cl. G06F 3/00

(52) U.S. Cl. 710/38

(57) ABSTRACT

The invention is to provide a centralized computer system, i.e., the so-called blade PC system. The centralized computer system according to the invention includes a plurality of centralized and bladed hosts. In particularly, the centralized computer system according to the invention enables two sets of I/O peripherals to operate the same host in a hardware-driven way.

### BACKGROUND OF THE INVENTION

1. Field of the Invention

This present invention relates to a centralized computer system, i.e., the so-called blade PC system and, more particularly, to a centralized computer system where two sets of I/O peripherals are enabled to operate the same host simultaneously in a hardware-driven way.

2. Description of the Prior Art

Many commercial businesses and enterprises make extensive use of personal computers (PCs) in their daily operations. In a typical manner, each user of a PC in the enterprise has a networked PC at his/her desk or in the working area. As the number of networked computer systems utilized in an enterprise increases, the management of resources in the network may become increasingly complex and expensive. Therefore, some of the manageable issues involved in maintaining a large number of networked computer systems are required to be taken into consideration, including the ease of installation and deployment, the topology and physical logistics of the network, asset management, scalability (the cost and effort involved in increasing the number of units), troubleshooting network or unit problems, support costs, software tracking and management, the issue of physical space such as space of the floor space or room on the desk, as well as security issues regarding physical assets, information protection, software control, and computer viruses.

To overcome the mentioned-above problems, many IT companies have developed the centralized computer systems. Please refer to FIG. 1. FIG. 1 is a schematic diagram illustrating an infrastructure of a typical centralized computer system 1. As shown in FIG. 1, the centralized computer system 1 includes a plurality of hosts 12, where each host 12 is equipped with and operated by a set of peripherals 14 including at least one peripheral device. The hosts 12 in the centralized computer system 1 are bladed, i.e., each of the hosts 12 is implemented into a “card”. In other words, each host 12 comprised on a circuit card includes the components of the standard computer system. The centralized computer system 1 also includes a network 16 to provide the hosts 12 to communicate with the remote peripheral devices. As shown in FIG. 1, each set of peripherals 14 may include a display 142, a keyboard 144, a mouse 146, and/or other peripheral devices for human interface. The centralized computer system 1 communicates with one set of peripherals 14 coupled to the host 12 by sending and receiving encoded I/O signals transmitted over the network 16. In general, a host switch (not shown in FIG. 1), connecting with the I/O interface of a host 12 in the centralized computer system 1. Relatively, each set of I/O peripherals 14 is equipped with a peripheral switch 148 coupled to all of the peripheral devices of the set of I/O peripherals 14. And, the I/O signals transmitted between one host 12 and the assigned set of I/O peripherals 14 are encoded and decoded by the corresponding host switch and the corresponding peripheral switch 148, transmitted over the network 16. The network 16 may be a Local Area Network (LAN), such as an intranet, or a Wide Area Network (WAN), such as the Internet, though other networks are taken into account.

On summary, the distinct features and advantages of the typical centralized computer system are as follows:
(a) the centralized computer system can include at least ten hosts in a chassis;
(b) because the hosts are bladed to reduce the volume, more hosts can be configured by a designer in the same space.
(c) because the centralized computer system is a highly integrated system, providing a management host to control and search the whole system is necessary;
(d) the hosts are centralized in the computer room to prevent man-made destruction and information stealing;
(e) by means of the setting of certain software, the user can read and retreat data but copy;
(f) because the hosts are centralized in the computer room, the user won't hear the noise generated by fans;
(g) with the centralized computer system, there are only a keyboard, a mouse, a display and a network connector on the user's desk, i.e., the user has more spatial usability;
(h) with the centralized computer system, two set of I/O peripherals are enabled to operate the same host;
(i) with the centralized computer system, the manager can seamlessly monitor other hosts without being found out by other users; and
(j) with the centralized computer system, seamlessly broadcasting to all users is much easier.

However, the solutions for enabling two sets of I/O peripherals to operate the same host nowadays are all required to utilize software. That is, the host computer and the guest computer all need to install the same application software before the operation of two sets of I/O peripherals for the same host. And, all processes should be operated under the operating system (OS). In addition, the control function can be operated only when application software supporting the control function is driven.

Accordingly, one scope of the invention is to provide a centralized computer system and a controlling method in a centralized computer system where two sets of I/O peripherals are enabled to operate the same host in a hardware-driven way rather than a software-driven way.

### SUMMARY OF THE INVENTION

The invention is to provide a controlling method used in a centralized computer system. The centralized computer system includes a network, a first host, a first host switch which connects with the I/O interface of the first host, a first peripheral switch, a first set of I/O peripherals, a second peripheral switch, and a second set of I/O peripherals. The second peripheral switch includes a display and is electrically connected to the N I/O devices; N is a natural number. The first host switch has a plurality of I/O ports. The first set of I/O peripherals are assigned to operate the first host such that I/O signals transmitted between the first host and the first set of I/O peripherals are encoded and decoded by the first host switch and the first peripheral switch, transmitted over the network. The controlling method is to enable the second set of I/O peripherals to operate the first host. The method according to the present invention first encodes a video output signal of the I/O signals, and then redirects the encoded video signal not only to the first peripheral switch but also to the second peripheral switch over the network. The second peripheral switch receives the encoded video signal, decodes the encoded video signal into the video signal, and outputs the video signal to the display. Subsequently, designate each of N I/O ports among the plurality of I/O ports of the first host switch to one of the N I/O devices of the second set of I/O peripherals. Finally, according to the physical addresses of the designated I/O ports, encode and/or decode the I/O signals transmitted between the first host and the second set of I/O peripherals by the first host switch and the second peripheral switch, and transmitted the encoded I/O signals over the network.

Besides, the invention is to provide a centralized computer system. The centralized computer system includes a network, a first host, a first host switch, a first peripheral switch, a first set of I/O peripherals, a second peripheral switch and a second set of I/O peripherals. The first host switch, connected with the I/O interface of the first host and linked to the network, has a plurality of I/O ports. The first peripheral switch is links to the network. The first set of I/O peripherals have at least one first display, electrically connected to the first peripheral switch, and M first I/O devices electrically connected to the first peripheral switch, wherein M is a natural number. The second peripheral switch is links to the network. The second set of I/O peripherals have at least one second display, electrically connected to the second peripheral switch, and N second I/O devices is electrically connected to the second peripheral switch, wherein N is a natural number. The first host switch encodes a video output signal of the I/O signals, and redirects the encoded video signal not only to the first peripheral switch but also to the second peripheral switch over the network. The first peripheral switch receives the encoded video signal, decodes the encoded video signal into the video signal, and outputs the video signal to the first display. The second peripheral switch receives the encoded video signal, decodes the encoded video signal into the video signal, and outputs the video signal to the second display. Each of M first I/O ports among the plurality of I/O ports of the first host switch is designated to one of the M first I/O devices of the first set of peripherals. The first host switch and the first peripheral switch encode and/or decodes, according to the physical addresses of the designated first I/O ports and the I/O signals transmitted between the first host and the first set of I/O peripherals, and the encoded I/O signals are transmitted over the network. Each of N second I/O ports among the plurality of I/O ports of the first host switch is designated to one of the N second I/O devices of the second set of peripherals. The first host switch and the second peripheral switch encode and/or decodes, according to the physical addresses of the designated second I/O ports and the I/O signals transmitted between the first host and the second set of I/O peripherals, and the encoded I/O signals are transmitted over the network. In this way, the first set of I/O peripherals and the second set of I/O peripherals are enabled to operate the first host.

The advantage and spirit of the invention may be understood by the following recitations together with the appended drawings.

### BRIEF DESCRIPTION OF THE APPENDED DRAWINGS

FIG. 1 is a schematic diagram illustrating an infrastructure of a typical centralized computer system; and

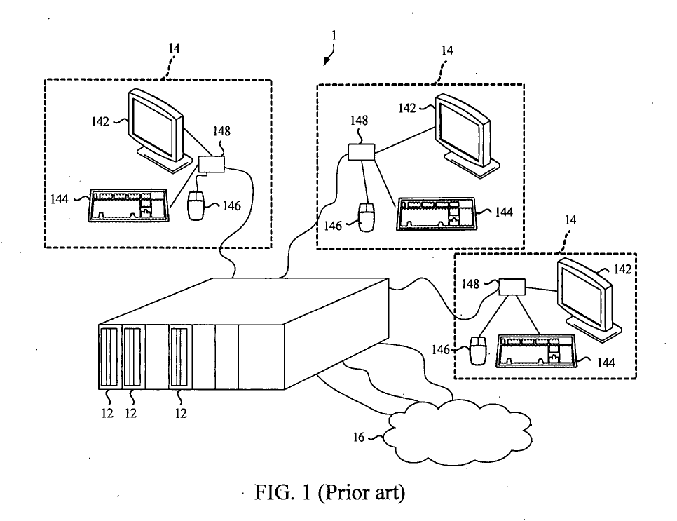

FIG. 2 is a schematic diagram illustrating an infrastructure of a centralized computer system of a preferred embodiment of the present invention.

### DETAILED DESCRIPTION OF THE INVENTION

The present invention is to provide a centralized computer system and a controlling method in a centralized computer system where two sets of I/O peripherals are enabled to operate the same host in a hardware-driven way rather than a software-driven way. The preferred embodiments of the invention will be described in detail below, so as to fully describe the features, the spirits, the advantages, and the easiness of the practice

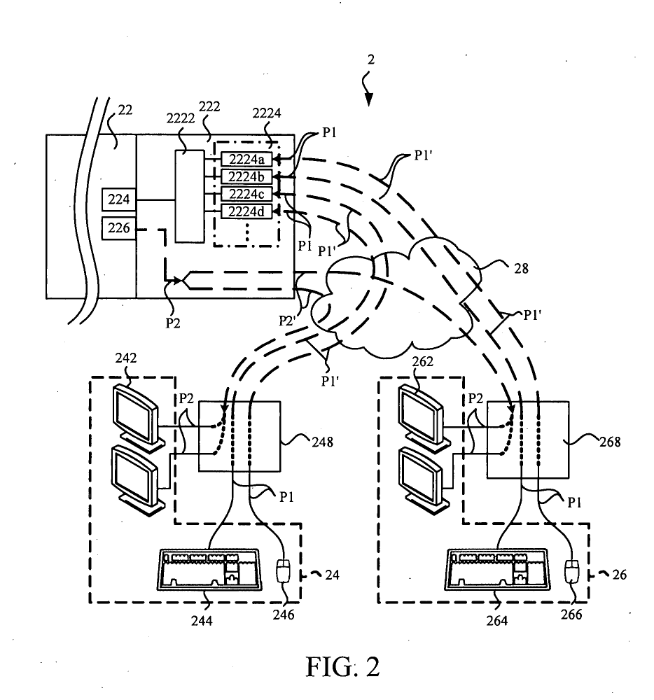

Please refer to FIG. 2. FIG. 2 is a schematic diagram illustrating an infrastructure of a centralized computer system of a preferred embodiment of the present invention. As shown in FIG. 2, the centralized computer system 2 includes a network 28, a first host 22, a first host switch 222, a first peripheral switch 248, and a second set of I/O peripherals 26. The first host switch 222 is connected with the first host 22 and linked to the network 28. The first host switch 222 has a plurality of I/O ports 2224, such as I/O port 2224a, 2224b, 2224c and 2224d shown in FIG. 2.

As shown in FIG. 2, a first set of I/O peripherals 24 includes a first display 242 and M first I/O devices, such as a keyboard 244, a mouse 246, etc., wherein M is a natural number. The first display 242 and M first I/O devices are respectively electrically connected to the first peripheral switch 248. And the first peripheral switch 248 is linked to the network 28.

As shown in FIG. 2, a second set of I/O peripherals 26 includes a second display 262 and N second I/O devices, such as a keyboard 264, a mouse 266, etc., wherein N is a natural number. The second display 262 and N second I/O devices are respectively electrically connected to the second peripheral switch 268. And the second peripheral switch 268 is linked to the network 28.

As shown in FIG. 2, the first host switch 222 encodes a video output signal P2 of the I/O signals 2482, and redirects the encoded video signal P2′ to the first peripheral switch 248 and to the second peripheral switch 268 over the network 28. The first peripheral switch 248 receives the encoded video signal P2′, decodes the encoded video signal P2′ into the video signal P2′ and outputs the video signal P2′ to the first display 242. Similarly, the second peripheral switch 268 receives the encoded video signal P2′, decodes the encoded video signal P2′ into the video signal P2′ and outputs the video signal P2′ to the second display 262.

As shown in FIG. 2, the first host switch 222 is capable of designating each of M first I/O ports among the plurality of I/O ports 2224 to one of the M first I/O devices of the first set of I/O peripherals 24. The first host switch 222 and the first peripheral switch 248 encode and/or decode, according to the physical addresses of the designated first I/O ports 2224 and I/O signals transmitted between the first host 22 and the first set of I/O peripherals 24, and the encoded I/O signals are transmitted over the network 28. As shown in FIG. 2, the I/O signals which have not been encoded or have decoded are marked as P1, and the I/O signals which have been encoded are marked as P1′.

As shown in FIG. 2, the first host switch 222 is capable of designating each of N second I/O ports among the plurality of I/O ports 2224 to one of the N second I/O devices of the second set of I/O peripherals 26. The first host switch 222 and the second peripheral switch 268 encode and/or decode, according to the physical addresses of the designated second I/O ports 2224 and the I/O signals transmitted between the first host 22 and the second set of I/O peripherals 26, and the encoded I/O signals are transmitted over the network 28. As shown in FIG. 2, the I/O signals which have not been encoded or have decoded are marked as P1, and the I/O signals which have been encoded are marked as P1′. In this way, the first set of I/O peripherals 24 and the second set of I/O peripherals 26 are enabled to operate the first host 22.

In one embodiment, the first host 22 has a USB controller and a video controller 226. The first host switch 222 includes a USB hub device 2222. The USB hub device 2222 is electrically connected to the USB controller for providing and managing the I/O ports 2224. And the video controller 226 is for controlling the video signal P2.

The following will explain a controlling method according to a preferred embodiment of the present invention which is used in the centralized computer system 2 shown in FIG. 2. The infrastructure of the centralized computer system 2 can be referred in FIG. 2. It is notable that the first set of I/O peripherals 24 is assigned to operate the first host 22 such that I/O signals transmitted between the first host 22 and the first set of I/O peripherals 24 are encoded and decoded by the first host switch 222 and the first peripheral switch 248, and is also transmitted over the network 28. Furthermore, according to the controlling method of the invention is to enable the second set of I/O peripherals 26 to operate the first host 22.

First, according to the controlling method of the present invention to encode a video output signal P2′ of the I/O signals 2482 and redirect the encoded video signal P2′ not only to the first peripheral switch 248 but also to the second peripheral switch 268 over the network 28. Next, the second peripheral switch 268 receives the encoded video signal P2′, decodes the encoded video signal P2′ into the video signal P2 and outputs the video signal P2′ to the display 262.

Then, according to the controlling method of the present invention, designate each of N I/O ports among the plurality of I/O ports 2224 of the first host switch 222 to one of the N I/O devices of the second set of I/O peripherals 26.

Finally, according to the physical addresses of the designated I/O ports 2224, encode and/or decode the I/O signals transmitted between the first host 22 and the second set of I/O peripherals 26 by the first host switch 222 and the second peripheral switch 268, transmitted the encoded I/O signals over the network 28. In this way, the first set of I/O peripherals 24 and the second set of I/O peripherals 26 both are able to operate the first host 22.

With the example and explanations above, it is obviously that according to the centralized computer system and the controlling method in a centralized computer system, two sets of I/O peripherals are enabled to operate the same host in a hardware-driven way, and the inconvenience caused by using software to achieve the same purpose is prevented.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. In a centralized computer system comprising a network, a first host, a first host switch connecting with the I/O interface of the first host, a first set of I/O peripherals equipped with a first peripheral switch, and a second set of I/O peripherals equipped with a second peripheral switch and comprising at least one display and N I/O devices electrically connected to the second peripheral switch, N being a natural number, the first host switch having a plurality of I/O ports, the first set of I/O peripherals being assigned to operate the first host such that I/O signals transmitted between the first host and the first set of I/O peripherals are encoded and decoded by the first host switch and the first peripheral switch, and are transmitted over the network, a method being for enabling the second set of I/O peripherals to operate the first host, said method comprising the steps of:
encoding a video output signal of the I/O signals, and redirecting the encoded video signal not only to the first peripheral switch but also to the second peripheral switch over the network, wherein the second peripheral switch receives the encoded video signal, decodes the encoded video signal into the video signal, and outputs the video signal to the display;
designating each of N I/O ports among the plurality of I/O ports of the first host switch to one of the N I/O devices of the second set of I/O peripherals; and
according to the physical addresses of the designated I/O ports, encoding and/or decoding the I/O signals transmitted between the first host and the second set of I/O peripherals by the first host switch and the second peripheral switch, and being transmitted the encoded I/O signals over the network.

2. The method of claim 1, wherein the I/O interface of the first host has a USB controller and a video controller, each of the I/O devices of the second set of I/O peripherals is a USB device, the first host switch comprises a USB hub device, electrically connected to the USB controller of the first host, for providing and managing the I/O ports of the first host switch. And, the video controller is for controlling the video signal.

3. A centralized computer system, comprising:
a network;
a first host;
a first host switch, connecting with the I/O interface of the first host and linking to the network, the first host switch having a plurality of I/O ports;
a first peripheral switch linked to the network;
a first set of I/O peripherals, comprising at least one first display, electrically connected to the first peripheral switch, and M first I/O devices electrically being connected to the first peripheral switch, M being a natural number;
a second peripheral switch linked to the network; and
a second set of I/O peripherals comprising at least one second display, electrically connected to the second peripheral switch, and N second I/O devices being electrically connected to the second peripheral switch, N being a natural number;
wherein the first host switch encodes a video output signal of the I/O signals, and redirects the encoded video signal not only to the first peripheral switch but also to the second peripheral switch over the network, the first peripheral switch receives the encoded video signal, decodes the encoded video signal into the video signal, and outputs the video signal to the at least first display, the second peripheral switch receives the encoded video signal, decodes the encoded video signal into the video signal, and outputs the video signal to the at least second display;
wherein each of M first I/O ports among the plurality of I/O ports of the first host switch is designated to one of the M first I/O devices of the first set of peripherals, the first host switch and the first peripheral switch encode and/or decodes, according to the physical addresses of the designated first I/O ports and I/O signals transmitted between the first host and the first set of I/O peripherals, and the encoded I/O signals are transmitted over the network;
wherein each of N second I/O ports among the plurality of I/O ports of the first host switch is designated to one of the N second I/O devices of the second set of peripherals, the first host switch and the second peripheral switch encode and/or decodes, according to the physical addresses of the designated second I/O ports and the I/O signals transmitted between the first host and the second set of I/O peripherals, and the encoded I/O signals are transmitted over the network; and
whereby the first set of I/O peripherals and the second set of I/O peripherals are enabled to operate the first host.

4. The centralized computer system of claim 3, wherein the I/O interface of the first host has a USB controller and a video controller, each of the I/O devices of the second set of I/O peripherals is a USB device, the first host switch comprises a USB hub device, electrically connected to the USB controller of the first host, for providing and managing the I/O ports of the first host switch. And, the video controller is for controlling the video signal.
